(19) United States
(12) Patent Application Publication
(10) Pub. No.: US 2023/0298280 A1
(43) Pub. Date: Sep. 21, 2023

(54) MAP FOR AUGMENTED REALITY

(71) Applicant: InterDigital CE Patent Holdings, SAS, Paris (FR)

(72) Inventors: Pierrick Jouet, Rennes (FR); Matthieu Fradet, Chanteloup (FR); Vincent Alleaume, PACE (FR); Caroline Baillard, Saint Sulpice La Foret (FR); Tao Luo, Cesson-Sevigne (FR); Anthony Laurent, Vignoc (FR)

(21) Appl. No.: 18/017,142

(22) PCT Filed: Jul. 6, 2021
(86) PCT No.: PCT/EP2021/068642

§ 371 Date: Jan. 20, 2023

(30) Foreign Application Priority Data
Jul. 21, 2020 (EP) 20305839.1

(51) Int. Cl. G06T 19/00; G06T 7/70

(52) U.S. Cl. CPC G06T 19/006; G06T 7/70

(57) ABSTRACT

In an augmented reality system, a map of the real environment is generated from a 3D textured mesh obtained through captured data representing the real environment. Some processing is done on the mesh to remove unnecessary elements and generate the map that comprises a set of 2D pictures: one picture for the ground level and one picture for the other elements of the scene. The generated map may then be rendered on an augmented reality device. The ground and the non-ground content may be rendered independently, then additional elements, such as other users of the augmented reality scene or virtual objects, are localized and represented in the map in real-time using a proxy. The rendering can be adapted to the user poses and to the devices themselves.

### TECHNICAL FIELD

At least one of the present embodiments generally relates to augmented reality and more particularly to the generation of a map representing the real environment and the association of this map to an augmented reality scene.

### BACKGROUND

Augmented reality (AR) is a concept and a set of technologies for merging real and virtual elements to produce visualizations where physical and digital objects co-exist and interact in real time. AR visualizations require a means to see augmented virtual elements as a part of the physical view. This can be implemented using an augmented reality terminal (AR terminal) equipped with a camera and a display, which captures video from the user's environment and combines this captured information with virtual elements on a display. Examples of such devices are such as smartphones, tablets or head-mounted displays. 3D models and animations are the most obvious virtual elements to be visualized in AR. However, AR objects can more generally be any digital information for which spatiality (3D position and orientation in space) gives added value, for example pictures, videos, graphics, text, and audio. AR visualizations can be seen correctly from different viewpoints, so that when a user changes his/her viewpoint, virtual elements stay or act as if they would be part of the physical scene. This requires capture and tracking technologies for deriving 3D properties of the environment to produce AR content by scanning the real environment, and when viewing the content, for tracking the position of the AR terminal with respect to the environment. The position of AR objects is defined with respect to the physical environment so that AR objects can be augmented into physical reality. The AR terminal's position can be tracked, for example by tracking known objects in the AR terminal's video stream or using one or more sensors. Typically, a known simple object (printed QR code, picture frame) with a known position within the virtual environment is used when starting an AR session to synchronize the localization.

A challenge for users of an augmented reality system is to localize themselves in the augmented environment. Even though AR applications take place in a physically bounded location such as a room, when a user focuses on his AR terminal, his/her orientation and perception of the environment can be biased. For example, the visual attention of the user is so focused on the screen of the AR terminal that sometimes she/he does not know where she/he is in the room. It is obviously the case for handheld video pass-through devices such as phones and tablets, but it is also true with head-mounted optical see-through displays, because of their limited field of view. To locate themselves in the real world, users are forced to leave their screen to look around, which is not very practical. Additionally, in case of a multi-user application, a user does not necessarily know where the others are located.

Hence it would be useful to display a bird-eye view of the environment (a kind of map) providing an overview of the entire environment and showing the location of other users of the augmented environment in real-time. Such solution is quite common in games and in VR applications since these applications are based on a virtual environment that is manually modeled. It is easy to extract a perfect map from such data. It is not so much used in AR, because generally AR applications are based on a scan of the real environment. This scan allows to correctly position the virtual scene on the top of the real environment. The 3D model of the room can be built from a set of photos taken to cover all the elements in the room, using 3D reconstruction methods for example based on Structure From Motion (SFM) or Multi-View Stereo (MVS) techniques. However, such reconstructed 3D models are often incomplete, noisy, and badly delimitated.

Embodiments described hereafter have been designed with the foregoing in mind.

### SUMMARY

In at least one embodiment, in an augmented reality system, a map of the real environment is generated from a 3D textured mesh obtained through captured data representing the real environment. Some processing is done on the mesh to remove unnecessary elements and generate the map that comprises a set of 2D pictures: one picture for the ground level and one picture for the other elements of the scene.

The generated map may then be rendered on an AR terminal. The ground and the non-ground content may be rendered independently, then additional elements, such as other users of the AR scene or virtual objects, are localized and represented in the map in real-time using a proxy. Finally, the rendering can be adapted to the user moves, poses and as well to the devices themselves.

A first aspect of at least one embodiment is directed to a method for creating a map representing an augmented reality scene comprising reconstructing a 3D textured mesh from captured data, splitting the reconstructed 3D textured mesh into a first 3D textured mesh in which data representing the ground of the scene have been removed, and a second 3D textured mesh representing the ground of the scene, and rendering a first picture from a top view of the first 3D textured mesh and a second picture from a top view at a detected ground level, wherein the map comprises the first and the second pictures.

A second aspect of at least one embodiment is directed to an apparatus for creating a map representing an augmented reality scene comprising a processor configured to reconstruct a 3D textured mesh from captured data, split the reconstructed 3D textured mesh into a first 3D textured mesh in which data representing the ground of the scene have been removed, and a second 3D textured mesh representing the ground of the scene, and render a first picture from a top view of the first 3D textured mesh and a second picture from a top view at a detected ground level, wherein the map comprises the first and the second pictures.

In variants of first and second aspects, the second 3D textured mesh representing the ground of the scene is replaced by a mesh using a polygonal shape based on intersection lines between detected wall planes and a ground plane, the texture of the second 3D textured mesh is determined by an image inpainting process or regenerated using a texture synthesis or filled uniformly with a single color value representing an average color of the original second picture, the rendering is done using an orthographic camera according to camera parameters based on boundaries of the second 3D textured mesh and pixel size of the first and second pictures, the orthographic camera used is positioned at the center of the augmented reality scene, the center being determined based on boundaries of the second 3D textured mesh, the 3D textured mesh from captured data is cleaned to remove isolated elements, the 3D textured mesh from captured data is cleaned to remove elements outside the detected wall planes and a ground plane of the second 3D textured mesh.

A third aspect of at least one embodiment is directed to a method for displaying a map representing augmented reality scene comprising obtaining data representative of an augmented reality scene, a map generated according to the first aspect, an information representative of user localization, data representative of a capture of the real environment, and displaying a representation of the data representative of a capture of the real environment, on which is overlaid a representation of the data representative of an augmented reality scene, on which is overlaid a representation of the map, on which is overlaid a representation of the user localization.

In variants of the third aspect, the size of the map is responsive to user input, the second picture related to the ground is displayed with a level of transparency.

A fourth aspect of at least one embodiment is directed to an augmented reality system comprising an augmented reality scene, an augmented reality controller, an augmented reality terminal, wherein a map generated according to the first aspect is associated to the augmented reality scene and displayed by the augmented reality terminal.

According to a fifth aspect of at least one embodiment, a computer program comprising program code instructions executable by a processor is presented, the computer program implementing at least the steps of a method according to the first aspect.

According to a sixth aspect of at least one embodiment, a computer program product which is stored on a non-transitory computer readable medium and comprises program code instructions executable by a processor is presented, the computer program product implementing at least the steps of a method according to the first aspect.

### BRIEF DESCRIPTION OF THE DRAWINGS

FIG. 1 illustrates a block diagram of an example of an augmented reality system in which various aspects and embodiments are implemented.

FIG. 2 illustrates a block diagram of an example implementation of augmented reality terminal according to an embodiment.

FIG. 3 illustrates a block diagram of an example implementation of augmented reality controller according to an embodiment.

FIG. 4 illustrates an example flowchart of process to generate an AR map according to at least one embodiment.

FIG. 5 illustrates an example flowchart of process to display an AR map according to at least one embodiment.

FIGS. 6A and 6B illustrate a reconstructed 3D textured mesh as generated in step 420 of the AR map generation process according to an embodiment.

FIGS. 7A and 7B illustrate a cleaned mesh as obtained in step 430 of the AR map generation process according to an embodiment.

FIG. 8A illustrates an example of orthographic projection used for the rendering step 430 of the map generation process according to an embodiment.

FIG. 8B illustrates an example of transformation used for the rendering step 430 of the map generation process according to an embodiment.

FIGS. 9A, 9B and 9C illustrate a second example of orthographic projection used for the rendering step 430 of the map generation process according to an embodiment.

FIG. 9D illustrates a second example of orthographic projection comprising a rotation used for the rendering step 430 of the map generation process according to an embodiment.

FIGS. 10A and 10B illustrate examples of rendering of the orthographic projection according to an embodiment. FIGS. 10C and 10D are simplified drawing equivalents representing these examples of rendering.

FIGS. 11A and 11B illustrate an example of result of step 450 of the map generation process according to an embodiment. FIGS. 11C and 11D are simplified drawing equivalents representing these examples of result.

FIG. 12A illustrates an example of a screenshot of the AR map as displayed on an AR terminal according to an embodiment. FIG. 12B is a simplified drawing equivalent representing this screenshot.

FIG. 13 illustrates an example of mapping between a world frame reference and the AR map reference axis.

FIG. 14A represents a screenshot of the display of an AR terminal positioned within the AR scene and showing the AR map. FIG. 14B is a simplified drawing equivalent representing this screenshot.

FIGS. 15A and 15B illustrate examples of display of an AR map on an AR terminal using a zooming feature according to an embodiment.

FIG. 16 illustrates an example of display of an AR map on an AR terminal using a transparency feature according to an embodiment.

FIGS. 17A and 17B illustrate examples of display of an AR map on an AR terminal using a user-centered cropping feature according to an embodiment.

### DETAILED DESCRIPTION

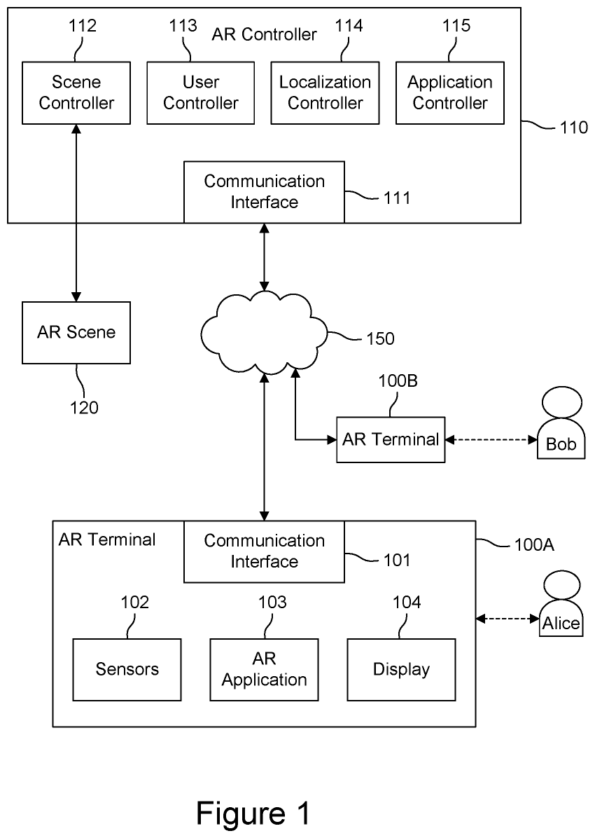

FIG. 1 illustrates a block diagram of an example of a system in which various aspects and embodiments are implemented. Multiple users—here Alice and Bob—can simultaneously view and interact with virtual objects from their position in an AR scene which is a shared augmented real-world 3D environment. Modifications in the AR scene can be visible in real time to every user. A digital representation of the AR scene 120 is handled by an AR controller 110 that also manages the coordination of the interactions between users in the augmented environment. The AR controller may comprise different functional elements. A Scene Controller 112 handles the generated environment data including the map. A User Controller manages the registered users using their AR terminals and notably their relocalization status and the current pose of the AR terminals. The module assigns an ID to a user when registering and removes it when the user unregisters i.e. when leaving the application. When a user is relocalized, he frequently transmits his pose to the server which then provides the pose to all the users participating to the AR experience. In this context of rigid objects, the pose is defined by a location and an orientation within a world frame coordinate system. A Localization Controller 114 performs a relocalization process to estimate the pose of the AR terminals in a shared world frame coordinate system. An Application Controller 115 manages data which are specific to a given application. In the example of an AR Chat application, this controller manages the messages sent by the users, informs the recipients when messages are available for them, etc.

To enjoy the AR scene, users will join other users in the shared augmented space using an AR terminal (100A, 100B). The AR terminal displays the virtual objects of the AR scene superimposed to the view of the real-world environment. To ensure consistent interactions with the AR scene, all AR terminals must be continuously localized in the same world frame coordinate system. AR terminals and the AR controller are exchanging data together through respective communication interfaces 111, 101 coupled to a communication network 150. This network is preferably wireless to provide mobility to the AR terminals.

From a functional point of view, AR terminals 100A, 100B may comprise sensing capabilities using sensors 102 such as cameras, inertial measurement units, various input controls (keys, touch screen, microphone), and display capabilities 104 to render the AR scene to the user. An AR application 103 allows to control the interactions between the user, the AR scene and the other users.

In a collaborative experience using the system of FIG. 1, the virtual objects are shared between all the users. Each user may use his own AR terminal to display the AR scene. Each user may be associated with an AR proxy that represents the user in the augmented environment. The pose of the AR proxy is associated to the pose of the AR terminal of the user. The AR proxy may take the form of a human-looking 3D model or any other virtual object. The users will move into the AR scene, interact with virtual objects of the shared AR scene or interact with other users through their AR proxy. For example, when Alice moves to the right, the AR terminal 100A will be moved to the right and thus the pose of the corresponding AR proxy within the AR scene will be updated by the AR controller 110 and be provided to the other AR terminals to be reflected into these devices so that Bob can visualize the move of Alice on his AR terminal 100B. Stability is essential to the overall success of the experience and more particularly regarding the positioning of the different AR terminals and tracking of their movements.

Defining the position and orientation of a real object in space is known as positional tracking and may be determined with the help of sensors. Sensors record the signal from the real object when it moves or is moved, and the corresponding information is analyzed with regards to the overall real environment to determine the pose. Different mechanisms can be used for the positional tracking of an AR terminal including wireless tracking, vision-based tracking with or without markers, inertial tracking, sensor fusion, acoustic tracking, etc.

In consumer environments, optical tracking is one of the techniques conventionally used for positional tracking. Indeed, typical augmented reality capable devices such as smartphones, tablets or head-mounted displays comprise a camera able to provide images of the scene facing the device. Some AR systems use visible markers like QR codes physically printed and positioned at a known location both in the real scene and in the AR scene, thus enabling to perform a correspondence between virtual and real worlds when detecting these QR codes.

Less intrusive markerless AR systems may use a two step approach where the AR scene is first modeled to enable the positioning in a second step. The modeling may be done for example through a capture of a real environment. Feature points are detected from the captured data corresponding to the real environment. A feature point is a trackable 3D point so it is mandatory that it can be differentiated from its closest points in the current image. With this requirement, it is possible to match it uniquely with a corresponding point in a video sequence corresponding to the captured environment. Therefore, the neighborhood of a feature should be sufficiently different from the neighborhoods obtained after a small displacement. Usually, it is high frequency point like a corner. Typical examples of such points are a corner of a table, the junction between the floor and the wall, a knob on a furniture equipment, the border of a frame on a wall, etc. An AR scene also be modeled instead of captured. In this case, anchors are associated to selected distinctive points in the virtual environment. Then, when using such AR system, the captured image from an AR terminal is continuously analyzed to recognize the previously determined distinctive points and thus make the correspondence with their position in the virtual environment allowing thus to determine the pose of the AR terminal.

In addition, some AR systems combines the 2D feature points of captured image with depth information for example obtained through a time-of-flight sensor or with motion information for example obtained from accelerometers, gyroscopes or inertial measurement units based on micromechanical systems.

According to the system described in FIG. 1, this analysis may be done fully in the AR terminals, fully done in the AR controller or the computations may be shared between these devices. Indeed, the detection of the distinctive point corresponds, in general, to the detection of feature points in a 2D image, for example using SIFT descriptor to identify the feature points. This can be quite resource consuming task, especially for mobile devices when the battery charge is limited. Therefore, AR systems may balance the computation workload by performing some of the computations in the AR controller, that is typically a computer or server. This requires transmitting the information gathered from the AR terminal sensor to the AR controller and the complete computation time must not exceed the duration between the display of two consecutive frames. This step includes the data transmission to the server and the computation result retrieval. Such solution is only possible for networks with low latency.

In order to minimize the positional tracking computation workload, some AR systems use a subset of selected feature points named anchors. While a typical virtual environment may comprise hundreds or thousands of feature points, anchors are generally predetermined within the AR scene, for example manually selected when building the AR scene. A typical AR scene may comprise around half a dozen of anchors, therefore minimizing the computation resources required for the positional tracking. An anchor is a virtual object defined by a pose (position and a rotation) in a world frame. An anchor is associated with a set of features points that define a unique signature. When an anchor has been placed in a zone of an AR scene, the visualization of said zone when captured by the camera of an AR terminal will lead to an update of the localization. This is done in order to correct any drifts. In addition, virtual objects of an AR scene are generally attached to anchors to secure their spatial position in the world frame.

Anchors may be defined using raycasting. Feature points are displayed as virtual 3D particles. The user will make sure to select an object belonging to a dense set, this will give a stronger signature to the area. The pose of the feature point hit by the ray will give the pose of the anchor.

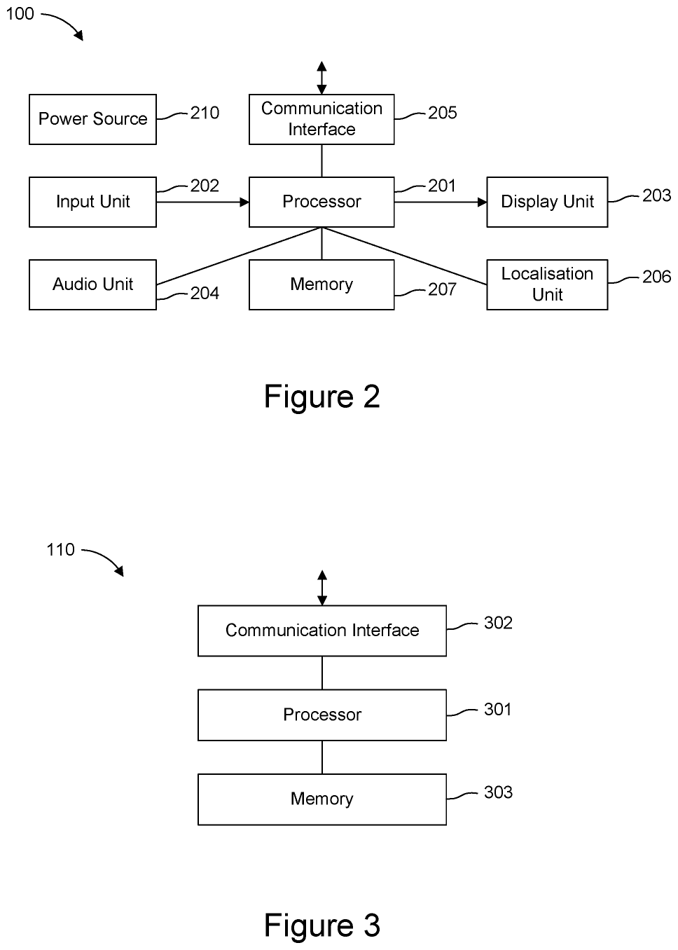

FIG. 2 illustrates a block diagram of an example implementation of augmented reality terminal according to an embodiment. Such apparatus corresponds to AR terminals 100A and 100B and implement the AR terminal functionalities introduced in FIG. 1. The AR terminal 100 may include a processor 201. The processor 201 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor may perform signal decoding, data processing, power control, input/output processing, and/or any other functionality that enables the AR terminal to operate in an augmented reality environment such as running an AR application.

The processor 201 may be coupled to an input unit 202 configured to convey user interactions. Multiple types of inputs and modalities can be used for that purpose. Physical keypad or a touch sensitive surface are typical examples of input adapted to this usage although voice control could also be used. In addition, the input unit may also comprise a digital camera able to capture still picture or video that are essential for the AR experience.

The processor 201 may be coupled to a display unit 203 configured to output visual data to be displayed on a screen. Multiple types of displays can be used for that purpose such as a liquid crystal display (LCD) or organic light-emitting diode (OLED) display unit. The processor 201 may also be coupled to an audio unit 204 configured to render sound data to be converted into audio waves through an adapted transducer such as a loudspeaker for example.

The processor 201 may be coupled to a communication interface 205 configured to exchange data with external devices. The communication preferably uses a wireless communication standard to provide mobility of the AR terminal, such as LTE communications, Wi-Fi communications, and the like.

The processor 201 may be coupled to a localization unit 206 configured to localize the AR terminal within its environment. The localization unit may integrate a GPS chipset providing longitude and latitude position regarding the current location of the AR Terminal but also other motion sensors such as an accelerometer and/or an e-compass that provide localization services. It will be appreciated that the AR terminal may acquire location information by way of any suitable location-determination method while remaining consistent with an embodiment.

The processor 201 may access information from, and store data in, the memory 207, that may comprise multiple types of memory including random access memory (RAM), read-only memory (ROM), a hard disk, a subscriber identity module (SIM) card, a memory stick, a secure digital (SD) memory card, any other type of memory storage device. In other embodiments, the processor 201 may access information from, and store data in, memory that is not physically located on the AR terminal, such as on a server, a home computer, or another device.

The processor 201 may receive power from the power source 210 and may be configured to distribute and/or control the power to the other components in the AR terminal 200. The power source 210 may be any suitable device for powering the AR terminal. As examples, the power source 210 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

While the figure depicts the processor 201 and the other elements 202 to 208 as separate components, it will be appreciated that these elements may be integrated together in an electronic package or chip. It will be appreciated that the AR Terminal 200 may include any sub-combination of the elements described herein while remaining consistent with an embodiment.

The processor 201 may further be coupled to other peripherals or units not depicted in FIG. 2 which may include one or more software and/or hardware modules that provide additional features, functionality and/or wired or wireless connectivity. For example, the peripherals may include sensors such as a universal serial bus (USB) port, a vibration device, a television transceiver, a hands free headset, a Bluetooth® module, a frequency modulated (FM) radio unit, a digital music player, a media player, a video game player module, an Internet browser, and the like.

As stated above, typical examples of AR terminal are smartphones, tablets, or see-through glasses. However, any device or composition of devices that provides similar functionalities can be used as AR terminal.

FIG. 3 illustrates a block diagram of an example implementation of augmented reality controller according to an embodiment. Such apparatus corresponds to the AR controller 110 and implements the AR controller functionalities introduced in FIG. 1. The AR controller 110 may include a processor 301. The processor 301 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor may perform signal decoding, data processing, power control, input/output processing, and/or any other functionality that enables the AR terminal to operate in an augmented reality environment, including the scene controller 112, user controller 113, localization controller 114 and application controller 115 introduced in FIG. 1.

The processor 301 may be coupled to a communication interface 302 configured to exchange data with external devices. The communication preferably uses a wireless communication standard to provide mobility of the AR controllers, such as LTE communications, Wi-Fi communications, and the like.

The processor 301 may access information from, and store data in, the memory 303, that may comprise multiple types of memory including random access memory (RAM), read-only memory (ROM), a hard disk, a subscriber identity module (SIM) card, a memory stick, a secure digital (SD) memory card, any other type of memory storage device. In other embodiments, the processor 301 may access information from, and store data in, memory that is not physically located on the AR controller, such as on a server, a home computer, or another device. The memory 303 may store the AR scene or the AR scene may be stored using an external memory.

The processor 301 may further be coupled to other peripherals or units not depicted in the figure which may include one or more software and/or hardware modules that provide additional features, functionality and/or wired or wireless connectivity. For example, the peripherals may include keyboard, display, various interfaces such as a universal serial bus (USB) port, a Bluetooth® module, and the like.

It will be appreciated that the AR controller 110 may include any sub-combination of the elements described herein while remaining consistent with an embodiment.

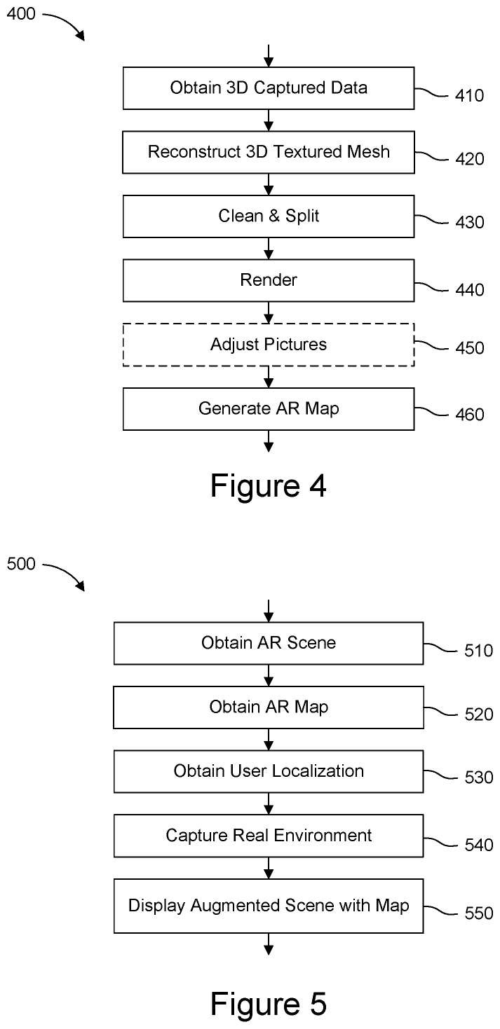

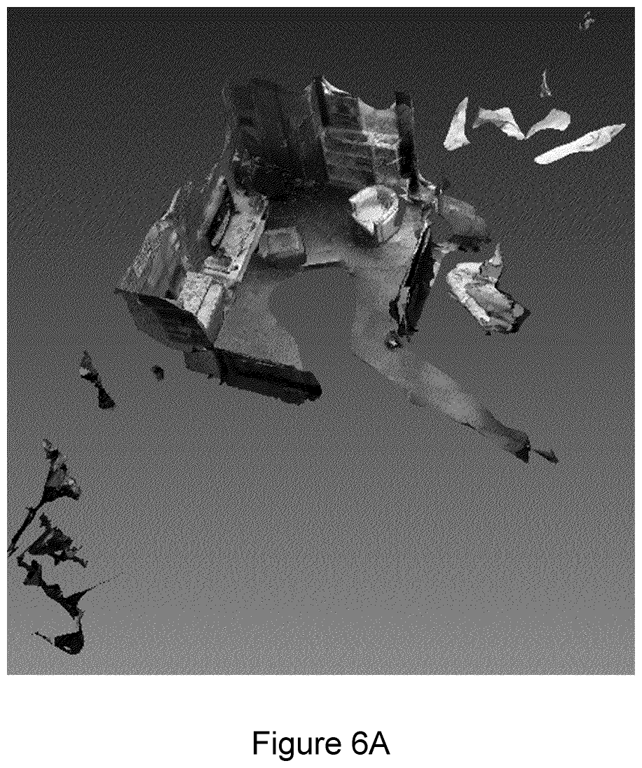

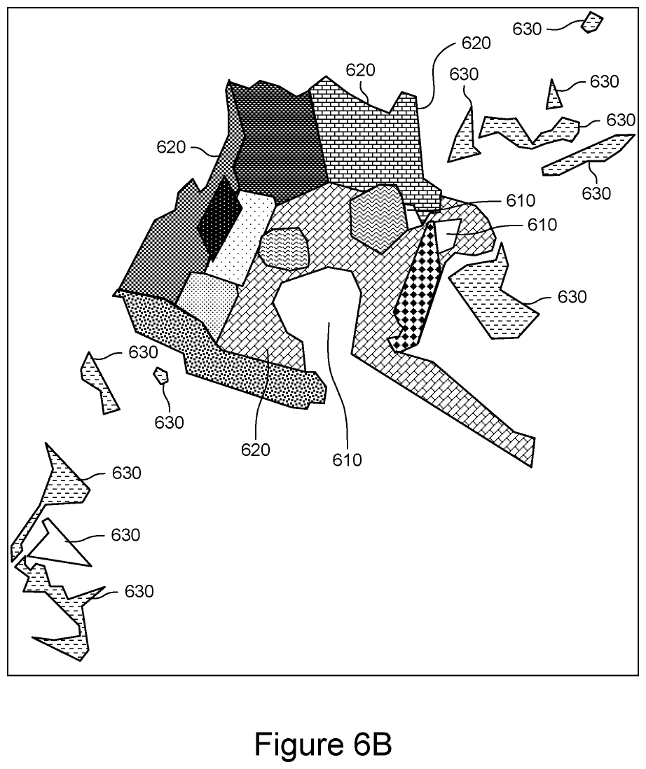

FIG. 4 illustrates an example flowchart of process to generate an AR map according to at least one embodiment. In step 410, the AR terminal first obtains data representing the real environment, the data being captured by the AR terminal. In an example implementation using the camera of the device, these data are a set of 2D images. In other implementation, other type of data may be acquired for example comprising depth information captured using a time-of-flight sensor. In step 420, a 3D textured mesh of the real environment is reconstructed. This mesh is for example built from the set of 2D images using 3D reconstruction techniques (such as SFM or MVS). Example of results of this operation are illustrated in FIGS. 6A and 6B. This capture requires that the user moves the AR terminal within the real environment to capture most of the surfaces of the real environment. The acquired data is preferably sanitized for example by removing isolated elements. The result of the reconstruction step is a 3D textured mesh. The reconstruction step is generally only performed once at the creation of the AR scene and is stored as an element of the AR scene. In further uses of the AR scene, the 3D textured mesh is directly available.

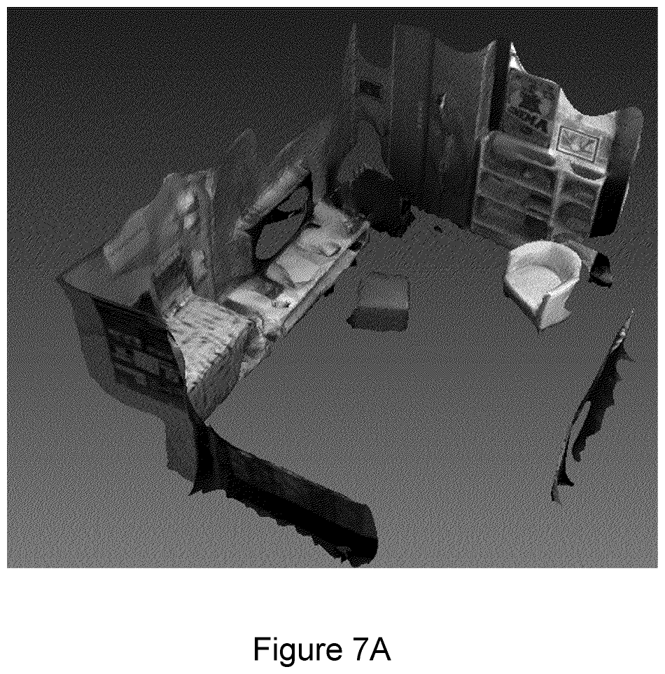

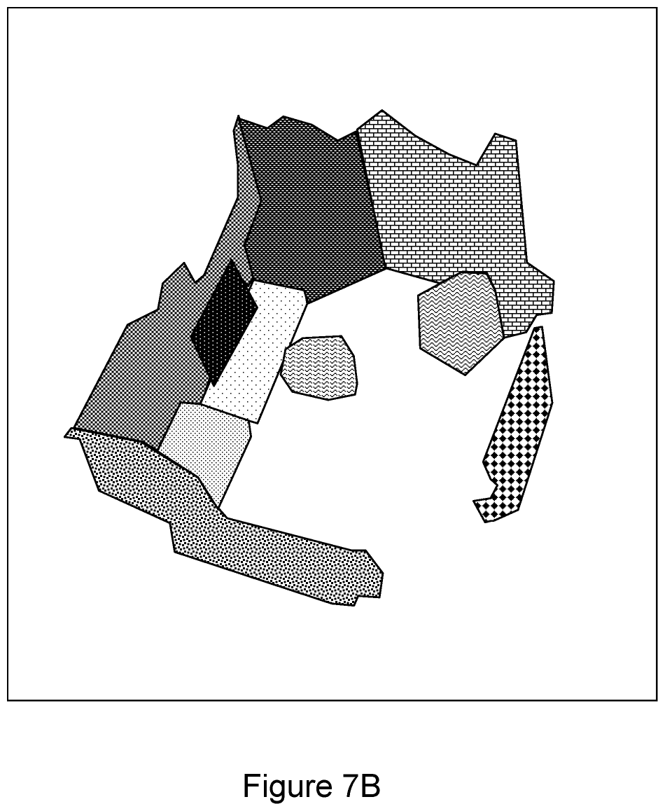

In step 430, the 3D textured mesh is split according to a planar analysis to determine horizontal and vertical planes. The ground plane is determined as being the horizontal plane at lowest vertical position. The ceiling plane is determined as being the horizontal plane at highest vertical position. The 3D mesh corresponding to the ceiling is removed. The wall planes are selected among the vertical planes that surround the scene. Ground corners are extracted as the intersection points between the wall planes and the ground plane and determine the ground area as being contained between four corners, in other words determining the scene boundaries. At that point, a second cleaning phase may be done by removing all the data located outside the bounded space. Indeed, these elements would be behind the walls. Also, the original 3D mesh data corresponding to the ground may also be removed. In addition, to remove the noisy reconstruction around ground, a margin value is also defined to remove the data above and below the detected ground plane. A separate mesh for the ground is built using a geometrical shape (generally a quadrilateral) based on the determined corners. As a result, the data comprises two 3D textured meshes: one very simple for the ground and one for the other elements of the scene, hereafter respectively named the ground mesh and the scene mesh. Examples of scene mesh at this stage of the process are illustrated in FIGS. 7A and 7B.

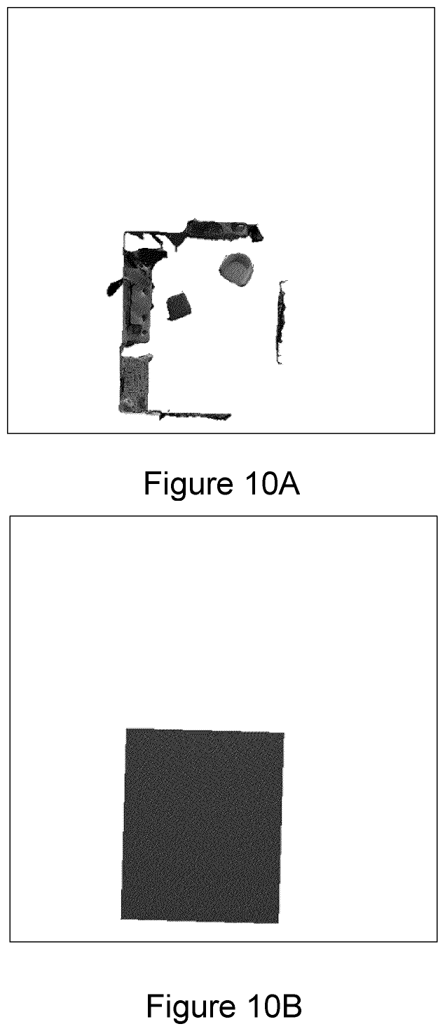

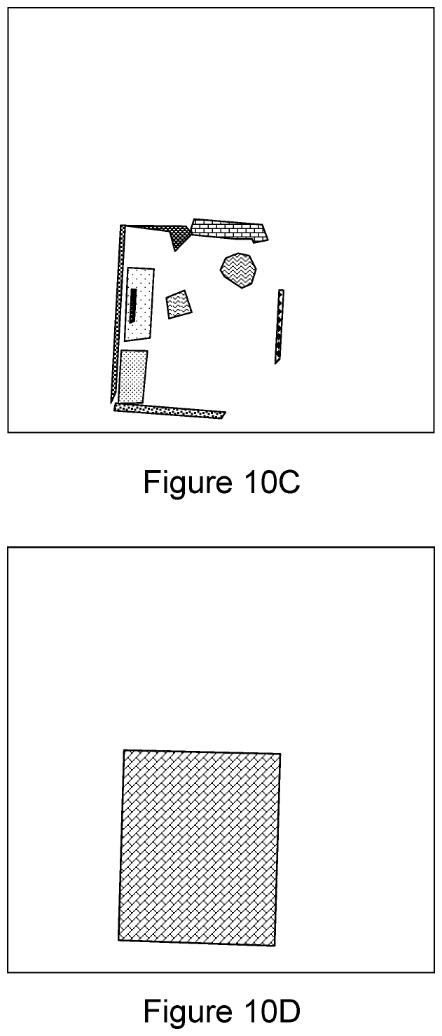

In step 440, the meshes are rendered from a top view to generate 2D images. For that purpose, an orthographic camera is positioned over the scene mesh, in direction to the ground, centered on the origin (point with null coordinates) of the 3D textured meshes, and the scale factor of the camera is adjusted so that the rendering cover the whole scene boundaries. This rendering generates two 2D images, one for the scene and one for the ground, as illustrated in FIGS. 10A and 10B.

In step 450, the scene and ground pictures rendered in step 440 may then adjusted when needed. Indeed, according to one rendering technique, the rendering may cover a lot of unnecessary space depending on the position of the origin of the 3D textured meshes. The ground picture is used as a mask to determine the cropping size and thus the size of the scene and ground pictures are reduced accordingly. Optionally, the ground and scene pictures may be rotated if needed. In at least one embodiment, the step 440 comprises an optimal positioning and scaling of the camera (and possibly rotation) over the center of the 3D textured meshes, so that the step 450 becomes unnecessary. Indeed, the rendering will directly provide the ground and scene pictures at the best size. This positioning may be done thanks to measurements of the ground corner positions in the 3D textured mesh.

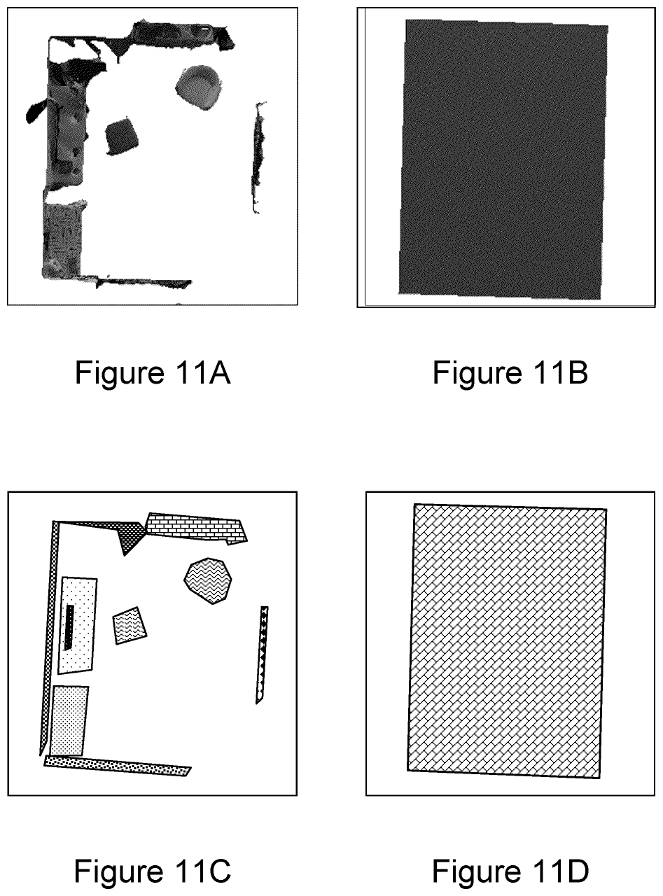

In step 460, the AR map comprising the ground and scene pictures is generated. Examples of these pictures are illustrated in FIGS. 11A to 11D. The AR map may then be stored in association to the AR scene.

The map generation process 400 may be executed by a standalone AR terminal or by an AR controller in combination with an AR terminal. In a typical implementation, the steps after the scanning are performed on an AR Controller to benefit from better computation resources available on such device.

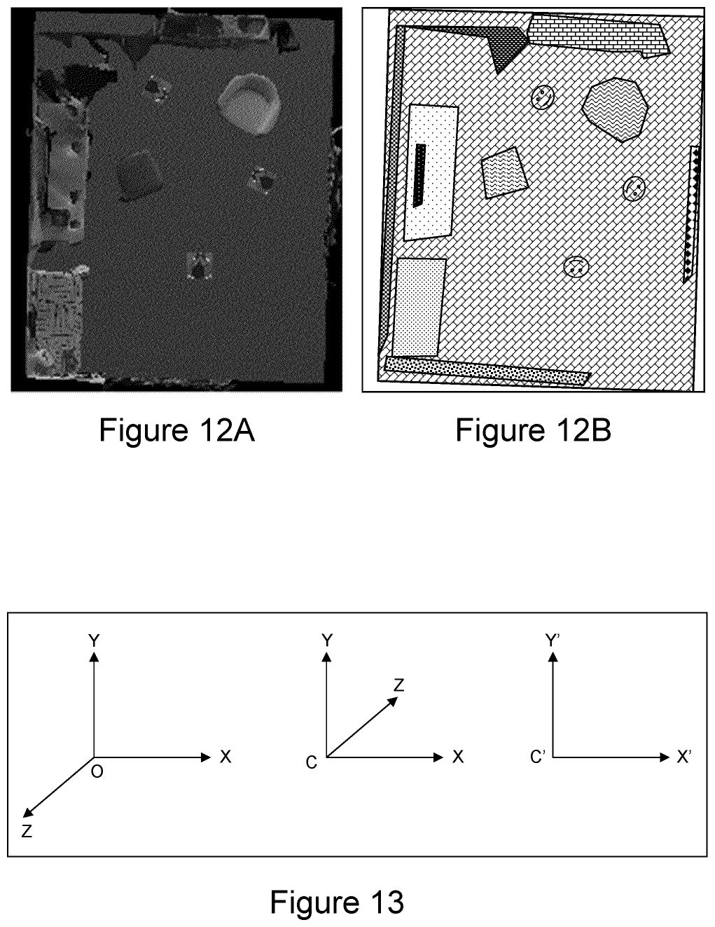

FIG. 5 illustrates an example flowchart of process to display an AR map according to at least one embodiment. The map display process 500 may be executed typically by an AR terminal in combination with an AR controller but may also be implemented by a standalone AR terminal. Please note that the steps 510 to 540 are about obtaining data and may be performed in any other order. In step 510, virtual elements of the AR scene are obtained. In step 520, the AR map associated to the AR scene is obtained. In step 530, the user localization is obtained. In step 540, the real environment is captured, for example by the camera of the AR terminal. In step 550, the display of the captured real environment is augmented by virtual objects of the AR scene. In addition, the AR map is displayed, overlaid on top of the other elements. An example of display is illustrated in FIG. 12A.

After this broad description, the description hereafter details the different steps of the processes to generate and display an AR map.

FIGS. 6A and 6B illustrate a reconstructed 3D textured mesh as generated in step 420 of the AR map generation process according to an embodiment. FIG. 6A is a black and white screenshot while FIG. 6B is a simplified drawing equivalent. Due to a limited number of views and the presence of occlusion during the capture of the real environment and also since reconstruction techniques do not allow a perfect 3D reconstruction, the reconstructed 3D textured mesh suffers from different issues. Firstly, the mesh may be incomplete with missing regions that were not captured. This situation is quite frequent on the floor as shown by areas 610 in FIG. 6B. Another problem is the non-delimitation of the space by well-defined walls as illustrated by areas 620. A third problem is the presence of outlier components due to an erroneous reconstruction, as illustrated by elements 630. Therefore, a first step after the reconstruction comprises removing these isolated elements.

FIGS. 7A and 7B illustrate a cleaned mesh as obtained in step 430 of the AR map generation process according to an embodiment. The scene model is analyzed to detect specific regions such as ground, ceiling, walls, and corners and determine some important values (sizes, position of scene with regards to the origin point).

The analysis uses a gravity direction that may be determined directly using the sensors equipped in the mobile device of capturing 3D model. For instance, in an example implementation based on an Android platform, a software-based gravity sensor estimates the direction and magnitude of gravity thanks to data provided by the accelerometer and magnetometer or gyroscope of the device. Moreover, the gravity direction can be indicated interactively by the user, in the case of the scene model containing a specific reference object that could be used to re-align that model regarding gravity direction. For instance, in the process of 3D modeling using a photogrammetry approach, the axes of a coordinate system may be indicated manually within a marker image, where Y-axis is inverse to the gravity direction. Then the reconstructed 3D model is transformed into a user-defined coordinate system, thanks to a reference object generally identified as the origin (point with null coordinates) in the virtual environment.

The proposed solution to identify the ground, walls and ceiling will take benefit of the presence of that reference object (or marker), assuming the following constraints:
first requirement is that the reference object would be a 3D or 2D shape, with known dimensions. Additionally the 2D shape case would require the object to have a unique texture (to allow its identification in captured images) and an attached 2D coordinate system (typically the 2 axes X, Y following the main dimensions of the 2D shape).
second requirement is to define and keep information about that the placement of the reference object in the scene. For instance, the reference object is placed on a horizontal surface in the scene, or instead a vertical one. This second requirement is relevant for consistent gravity direction determination, that is the gravity direction of the scene model is consistent to one axis indicating gravity direction from the 3D coordinate system defined for the reference object. In the case of a 2D reference object, such as for instance a specific planar sheet of paper following above requirement, it could be set for its general orientation on a planar surface of the scene on purpose (set on a table, ground, . . . or oppositely a wall) enabling the scene model process to provide a rescaled model aligned respectively to that marker, with axes X, Y being parallel to the main directions of that reference plane, and the Z axis being perpendicular to them, determined by cross as the normal of that plane.

With the determined direction of gravity, the planar analysis of the scene model can classify the detected planes into horizontal and vertical ones. Thus, the ground plane is determined as the furthest significant horizontal plane along the gravity direction. If it exists, the ceiling plane is determined as the furthest horizontal plane along the inverse gravity direction. And the wall planes are selected among the vertical planes that surround the scene.

A further cleaning can then be done to deal with the noisy data and the isolated components. The significant bounding planes of the scene (walls, ground, ceiling) are detected and the data elements located outside these bounding planes are removed.

For example, we assume that the indoor scene captured and reconstructed as illustrated in FIG. 6A can be bounded by a cuboid. The planes are extracted from the 3D model based on geometric criteria, then classified into horizontal and vertical planes, assuming that the gravity direction is the inverse direction of the Y-axis in the model coordinate system. Thus, the ground plane is determined as the furthest significant horizontal plane along the gravity direction. If it exists, the ceiling plane is determined as the furthest horizontal plane along the inverse gravity direction. The wall planes are selected among the vertical planes that surround the scene. In the case of the scene bounded by a cuboid, there exist four wall planes and the adjacent wall planes are perpendicular. Hence, a pair of adjacent vertical planes which are perpendicular is detected to determine the two main directions of walls using the normal directions of these two planes. And along each direction and its inverse direction, the furthest significant vertical planes are selected as the required wall planes. Finally, ground corners are extracted as the intersection points between the wall planes and the ground plane, which defines the ground area. All the data located outside the bounded space (a cuboid for the scene of FIG. 6A) can then be removed.

In addition, the original data of ground is also removed for better rendering of AR map and replaced by a separate mesh for the ground as mentioned earlier. The ceiling data, if any, is also removed. Thus, this step generates one 3D textured mesh for the scene and one (very simple) for the ground.

In complex scenes, the space is not limited in a cuboid. An analysis of the reconstructed mesh allows to detect when the room geometry is more complex than a cuboid. This is done thanks by checking the wall and ground intersections. The detection of ground or ceiling plane can be realized as the foregoing. Without the assumption of cuboid scene, the wall planes are selected from the vertical planes to bound the scene as well as possible. For instance, the 3D data of vertical planes with larger area size than a threshold are firstly projected on the detected ground plane. Then a convex hull can be computed from the projected points, which indicates the bounding of the significant scene data. And the wall planes are detected as the set of vertical planes which can best fit the convex hull. Thus, the adjacent wall planes are not necessary to be perpendicular and the number of walls planes can be arbitrary (larger than 2). In this case, a polygonal shape based on the intersection lines between the detected wall plane and the ground plane is used for the ground representation. Another problematic situation is when the real environment is not a closed space with obvious walls or when the walls are far away, for example beyond the scanning range of the device. In this case, the significant vertical planes, such as the furniture planes, form the bounding of the scene. The extraction of these planes can be controlled by configuring a threshold of the size of the area.

Regarding the ground plane, using the corners extracted by intersecting the walls and the ground, a corresponding planar shape is built. The result is generally quadrilateral or polygonal so that a simple meshing can be used. This quadrangle or polygon is positioned at the same height as the ground. For the texture, an average color close to the color of the floor can be chosen as simply as the mean or the median color over all original data of ground. A synthetic texture based on the captured picture of the ground may also be used for increased realism. The partial texture of the ground from the captured picture can be employed to generate the complete but partially synthetic texture using a method of image inpainting. For instance, the quadrangle or polygon is partially mapped with the texture and its fronto-parallel view is synthesized to be used as the input of image inpainting. Then the inpainted image is used as the synthetic texture. A method of texture synthesis can also be employed to generate a new texture image from only a small sample of the captured picture of the ground, i.e. by stitching together small patches of this sample until obtaining the as large as desired texture. Alternatively, the synthetic texture can also come from an available floor texture database: for each texture map available in the database, a similarity measure is computed between sample patches of the original ground texture and sample patches of the texture from the database. Such a similarity measure can be based on a combination of color similarity (sum of square difference for example) and texture similarity (based on Gabor filters for example). The texture from the database with the highest similarity to the original ground texture is retained and cropped to match the desired size. This textured quadrangle or polygon is then used to replace the original reconstructed ground. With this definition of the ground plane, the holes possibly corresponding to non-observed regions and so remaining in the ground after the reconstruction process are no more existing and the ground is completely defined.

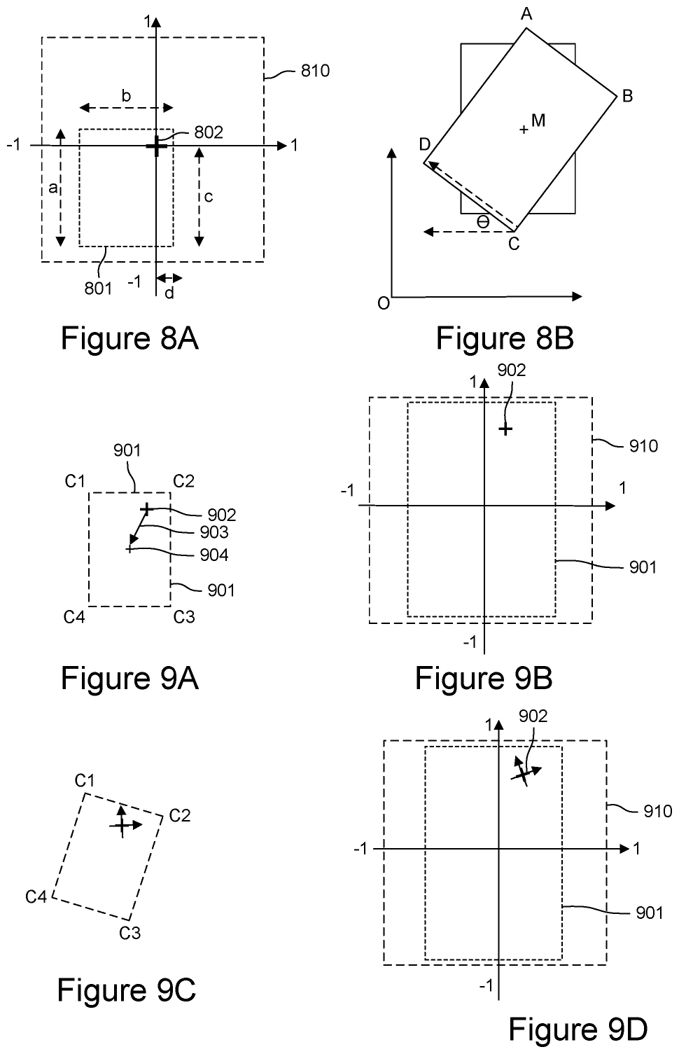

FIG. 8A illustrates an example of orthographic projection used for the rendering step 430 of the map generation process according to an embodiment. In a rendering framework, an orthographic camera (thus providing parallel projection) is placed vertically at a given altitude over the 3D textured meshes previously cleaned, the camera facing towards the ground floor. The scale factor is adjusted to get a top view showing the whole scene. This can be done thanks to the estimation of the corners. Indeed, since the reconstructed mesh comprises an object of known size (for example the frame mentioned above), it is possible to compute the real dimensions of the scene, and at least the distance between the corners of the scene. According to the desired dimensions of the map, the scale factor is then determined. In the example illustrated in the figure, the outer square 810 corresponds to the target image with a determined resolution, for example 512 by 512 pixels. The inner rectangle 801 is the top view of the scene as rendered by the camera. In this example embodiment, the scene origin (for example the frame mentioned above) and the center of the camera are aligned. The scale factor is then determined according to the largest distance from the center and in this example is equal to 1/c.

The 3D textured mesh of the scene and the 3D textured mesh of the ground are rendered separately but using the exact same camera setup and thus generate two pictures: one for the scene and one for the ground. The result of the rendering is illustrated in FIGS. 10A to 10D: FIG. 10A shows a screenshot of the rendering of the 3D textured mesh of the scene, FIG. 10 B shows a screenshot of the rendering of the 3D textured mesh of the ground while FIGS. 10C and 10D are simplified drawing equivalents representing the screenshots.

After this rendering, the obtained pictures are cropped according to the ground picture. The ground picture is used as a mask for cropping. In other words, the unused areas of the ground picture define minimal and maximal values in horizontal and vertical directions. The values are used as cropping limits for both the scene picture and the ground picture itself so that only the pixels inside these limits are kept in the resulting pictures. This corresponds to the first part of step 440 of the generation process. An example of result of this cropping is illustrated in FIGS. 11A to 11D.

FIG. 8B illustrates an example of transformation used for the rendering step 430 of the map generation process according to an embodiment. Indeed, when the axes of the camera and of the 3D textured mesh are not perfectly aligned, the projection results in a rotated 2D image. This may be corrected by applying a transform to all points of the scene picture and the ground picture itself. To compute the angle of rotation θ, we use the dot product. The final transform is the following matrix product:

Transform=T(O→M)*(R)*T(M→O)
where T is a translation and R is a rotation matrix

$$R = ( \begin{matrix}cos ⊖ & - sin ⊖ \\ sin ⊖ & cos ⊖\end{matrix} )$$

Applying this transform to the scene picture and the ground picture results in the final corrected images. These images form the foundation of the AR map.

FIGS. 9A, 9B and 9C illustrate a second example of orthographic projection used for the rendering step 430 of the map generation process according to an embodiment. In this embodiment, the process of FIGS. 8A and 8B are optimized by exploiting the determined dimensions of the walls to align the center of the camera with the center of the scene, determining the scale and optionally rotating the camera. As a result, the rendering of the 3D textured mesh directly provides the images of the scene picture and ground picture, without requiring further cropping and transformation. This process is applied to the scene mesh as well as to the ground mesh.

FIG. 9A illustrates a first example without rotation, in other words the walls are parallel to one axis of the 3D textured mesh coordinate system. In a first step, a width W and height H of the scene 901 are determined based on the distances between outer corners C1 to C4 of the scene, conventionally expressed in meters. This will determine a scale factor SF to be used, being the inversely proportional to the largest value of either the width or the height:

SF=1/(Max(H,W)/2)

Thus, for a room whose dimensions are 3 by 4 meters, a scale factor of 0.5 will be determined. In a second step, the distance of the corners is then determined with respect to the 3D textured mesh origin point 902. The corner with highest coordinates (Cx, Cy) is then selected. In the example of the figure, this corner is C2. A translation vector 903 is then determined as follows:

Tx=Cx−W/2

Ty=Cy−H/2

Once these parameters have been determined, it is possible to position the camera at the center of the scene 904 using the translation vector 903 and adjust the scale to the scale factor SF in order to generate an optimal 2D image of the 3D textured mesh. In order to ensure a better distinguishability of the walls, it is preferred to add a safety factor to the scale factor to cover some empty space around the scene. For example, if the scene width is 10 meters, the determined scale factor would be 1/10/2=0.2. A safety factor of 10% would reduce this value to 0.18, thus effectively covering a greater space roughly equivalent to 11 meters. FIG. 9A illustrates the settings required for a generation according to these principles where the camera captures the image 910 of the scene 901.

FIG. 9D illustrates a second example comprising a rotation, in other words the walls are not parallel to the axis of the 3D textured mesh coordinate system. Using the same principles as before, and adding the rotation described in FIG. 8B, the FIG. 9D shows the camera settings to be used.

Compared to the first example of orthographic projection, the second example of orthographic projection provides a better-quality image since the full resolution of the camera is used to generate the image and no cropping must be done afterwards. It allows to generate directly the images shown in FIGS. 11A to 11D.

FIGS. 11A, 11B, 11C and 11D illustrate an example of result of step 450 of the map generation process according to an embodiment. FIG. 11A shows an example of scene picture generated according to the previous steps, FIG. 11B shows an example of ground picture generated according to the previous steps while FIGS. 11C and 11D are simplified drawing equivalents representing these pictures. These pictures compose the AR map. This AR map may be packaged according to the AR system used and is preferably associated to the corresponding AR scene. In at least one embodiment, the AR map is a parameter of the AR scene and may be stored by the AR controller with the AR scene. An AR terminal can then obtain the AR map together with the AR scene. In at least one embodiment, the ground picture is not used and thus the AR map only comprises the scene picture.

FIGS. 12A and 12B illustrate an example of display of the map according to an embodiment. FIG. 12A represents a screenshot of the AR map as displayed on an AR terminal 100. FIG. 12B is a simplified drawing equivalent representing this screenshot. The AR map displays the scene picture overlaid over the ground picture but also shows the position of three users, symbolized by smileys in FIG. 12B. Indeed, in at least one embodiment, the AR map may also comprise additional elements such as the position of the user within the scene, the position of other users (more exactly the position of the AR terminal used by the users) and/or virtual objects. These additional elements are represented by the icon that is positioned at the location on the AR map corresponding to its localization in the real environment for the users and in the virtual environment for the virtual objects. The orientation of the users and virtual objects is represented by a rotation of the corresponding icon.

This is made possible by the tracking of AR terminals and by the knowledge of the virtual objects of the AR scene by the AR controller. In a multi user application, each AR terminal regularly provides its position to the AR controller which then provides this information to all the other AR devices. Then, these devices can update the positions of other users on the map using a specific icon per user or a specific color per user. In the screenshot of FIG. 12A, the three icons representing three users would be displayed in three different colors for example.

Tracking the AR terminal in the world space allows the system to show the virtual scene from the user's perspective. Indeed, it is possible to know exactly the position and the orientation of the AR terminal in the world frame in real time and to update it accordingly.

The notation for homogeneous transformation 4×4 matrix T is the following:

$$T = ( \begin{matrix}R & t \\ 0 & 1\end{matrix} ) ,$$

where is represents the rotation, t represents the translation.

The pose of the camera C1 of an AR terminal (in the world frame) is the following transform:

^{w}T_{C1}

Therefore, it is possible to transmit a 3D vector for the position and a quaternion for the orientation (rotation) of the AR terminal. These position and orientation can be shared amongst users of a common AR scene so that each of them can display the pose of the other users on his AR map.

FIG. 13 illustrates an example of mapping between a world frame reference and the AR map reference axis. Indeed, to position users or virtual objects within the AR map, we need to know where the world frame reference is. For this, the world frame coordinates are expressed relative to one corner C. As this is a 2D map we do not take the height into account. Then, we apply the scale factor SF. Therefore, all icons are positioned on the AR map relative to corner C with a size scale adjusted with respect to a display scale factor DSF.

One corner has to be defined as reference corner C, for example the bottom left corner. In a numeric example, if the position of the user in world frame coordinates are (−0.5,0.1,2), the coordinates of the C in world frame coordinates are (−1.5, −1.9,3), one meter is equivalent to 200 pixels (DSF=200).

The coordinates in pixel of the user on the AR map relative to C will be:

(−0.5+1.5)*200=200

(−2+3)*200=200(C is the new reference, we consider X′=X,Y′=−Z)

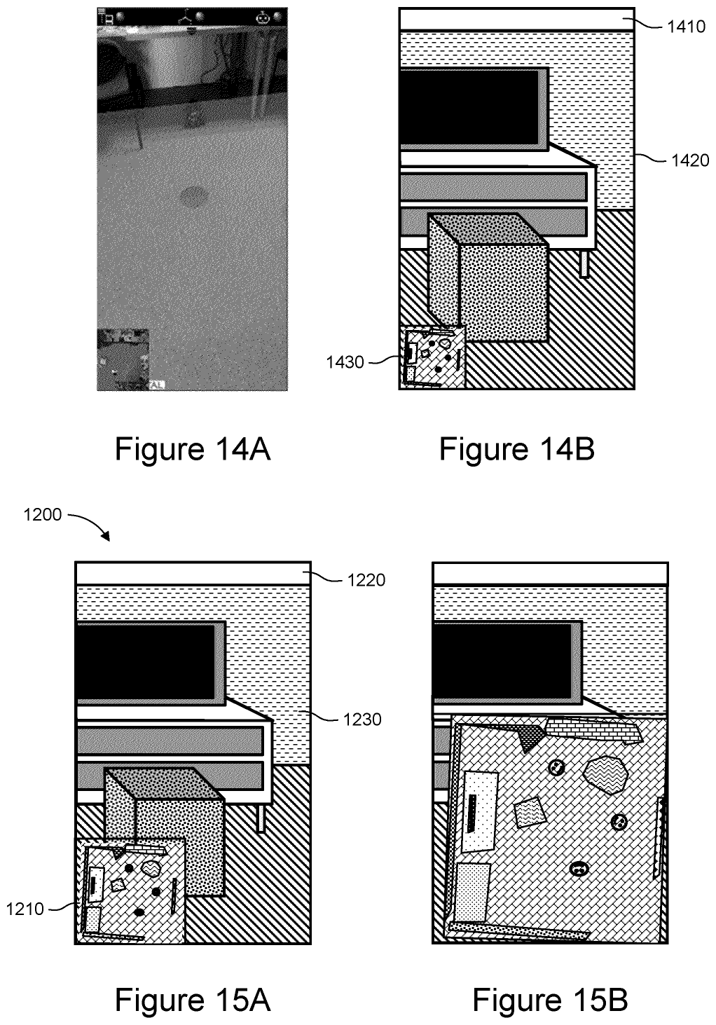

FIGS. 14A and 14B illustrate an example of display of an AR map on an AR terminal according to an embodiment. FIG. 14A represents a screenshot of the display of an AR terminal 100 positioned within the AR scene and showing the AR map. FIG. 14B is a simplified drawing equivalent representing this screenshot. Commonly, a canvas may be used to implement the user interface in an AR application. The AR map 1430 will be positioned in the user interface. The element 1410 represents a banner, the area 1420 displays the image captured by the camera of the AR terminal. In this example, the user is positioned in front of the television behind a cubic cushion. In this example, no virtual object is added to the real environment. The AR map 1430 is displayed in the lower left corner of the display and overlaps the image of the camera.

For the insertion of the AR map, we define an area with dimensions proportional to that of the final picture, then we will fit (interpolation and filtering) the picture in this area. The canvas settings automatically adapt to the resolution of the screen. This will optimize the resolution of the mini map.

The coordinates of the ground corners are expressed in the world coordinate system at real scale. We deduce a display scale factor from the affine transform which rescales the simple geometric shape formed by the ground corners to the canvas area.

FIGS. 15A and 15B illustrate examples of display of an AR map on an AR terminal using a zooming feature according to an embodiment. In some situations, on some AR terminals, the size of the AR map may be too small for the user. For that reason, a map zooming feature is provided in at least one embodiment. One example implementation for this feature is to detect a touch on the map area and increase the size of the AR map (for example double it) until one dimension of the screen is completely covered. A further touch will restore the original size.

The FIG. 14B has an original zoom value where the width of the AR map is one fourth of the width of the AR terminal display. When the user touches the AR map, the zoom value is doubled. The AR map is thus displayed on a large area so that its width is half the size of the AR terminal screen as illustrated in FIG. 15A. Another touch on the AR map area will double again the size of the AR map, as illustrated in FIG. 15B where the AR map covers the whole width of the AR terminal screen. A further touch on this area will return to the original size of FIG. 14B.

In another implementation, a slider allows to directly adjust the zoom level to a desired value and the size of the AR map is updated accordingly.

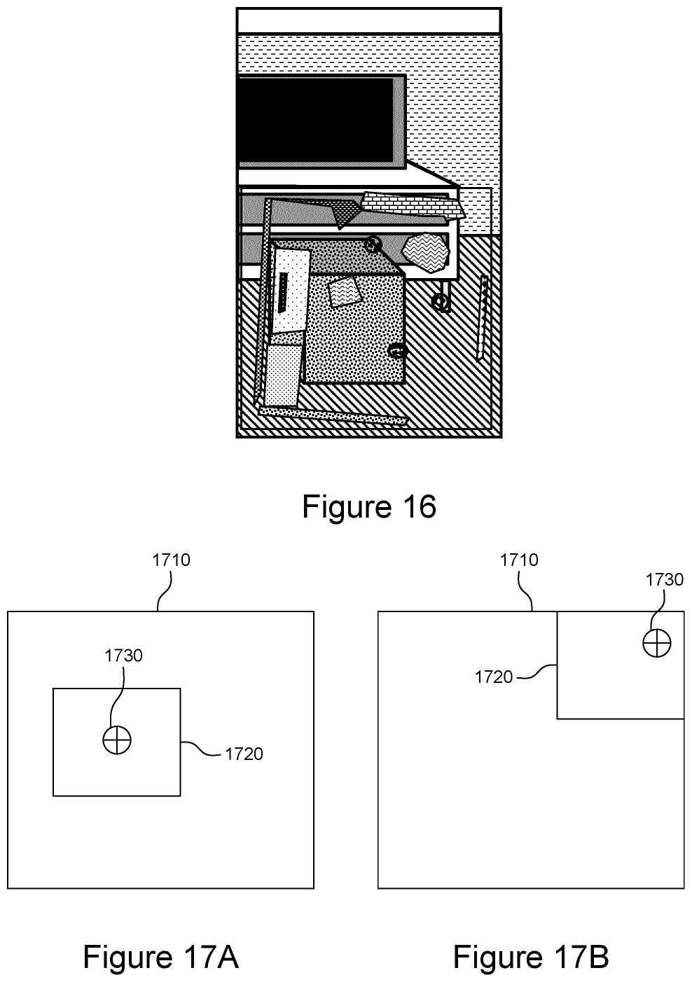

FIG. 16 illustrates an example of display of an AR map on an AR terminal using a transparency feature according to an embodiment. In the context of augmented reality, the user is seeing the rendered scene as a mix of real and virtual elements. It is important to avoid occluding large areas of that rendered scene by unnecessary or non-informative areas. Therefore, in at least one embodiment, the ground picture of the AR map is rendered as a semi-transparent area to keep other elements such as user's avatars, walls areas, objects as fully or more opaque areas. In at least one embodiment, the ground picture of the AR map is not displayed (or displayed as fully transparent), allowing the user to see through the AR map ground area and still able to visualize other real or virtual objects in the AR scene. This transparency feature is preferably under control of the user.

FIGS. 17A and 17B illustrate examples of display of an AR map on an AR terminal using a user-centered cropping feature according to an embodiment. Previous descriptions are using an AR map comprising the complete AR scene. This is not always possible. When the AR scene is very large, it is difficult to display the complete map in a viewable manner. In at least one embodiment, only a fraction of the complete map is displayed: the AR map is cropped to a reduced size fraction of the complete map and displayed in a user-centered manner according to the user position within the complete map. A floating window centered on the user's position on the AR map determines the cropped area to be displayed. For convenience, this window will have a proportional size relatively to the AR map, the result of the cropping will be fitted into the canvas area. In FIG. 17A, the element 1710 represents the complete map. Only the area 1720 will be displayed as the AR map. This area 1720 is moved according to the user position 1730.

The centering of the window is constrained by the edges of the mini map as illustrated in FIG. 17B where the user moved into a corner of the AR scene. Thus, the cropping is kept within the complete map area but no more centered around the user position.

The selection of this user-centered cropping feature is preferably under control of the user.

Other features not illustrated can further enhance the AR map.

According to at least one embodiment, the AR map is reoriented according to the orientation of the user within the AR scene, so that the top of the map represents the current orientation of the user. While the former description used an AR map with a fixed orientation, having a variable map orientation allows for improved way finding. Such feature is preferably used with a circular AR map instead of the square or rectangular AR map used throughout the description.

According to at least one embodiment, the AR map further displays labels to identify objects of the AR scene. These objects may be determined by a segmentation step of the AR scene to determine the objects and associate them labels. These elements can further be stored as parameters of the AR scene.

According to at least one embodiment, the AR controller stores the positions of the user over a period of time. This information is then used to display on the AR map the path followed by the users, for example represented as a trail of dots leading to the icon representing the user. The period of time may be adjusted to display either short-term movements (for example the last five seconds) making the map very dynamic or long-term movements for tracking all movements within an AR scene. When an identifier is associated to a set of positions, it is possible to know who and where was the corresponding user.

According to at least one embodiment, the computation workload of the AR terminal is reduced by performing some of the computations in the AR controller, that is typically a computer or server. This requires transmitting the information gathered from the AR terminal sensor to the AR controller.

According to at least one embodiment, an AR terminal also includes the functionalities of an AR controller and thus allows standalone operation of an AR scene, while still being compatible with embodiments described herein. In such mono user application, an on-board map may be used, locally updated with the user position (thanks to a marker for example).

Although the AR map generation process has been described above in a conventional client-server scenario using an AR controller and AR terminals, a peer-to-peer approach is also possible. In such implementation, all the role and functionalities we described as being on the AR controller would be spread on the set of clients for the current session. Some specific elements would need to be added though, to manage the sessions and clients discovery, session model and data persistency, as it is common in peer-to-peer network based system.

A mixed approach is also possible where a first AR terminal operates as a standalone AR system, hosting the AR scene, performing its own localization, enhancing the scene with virtual objects and switching to a peer-to-peer mode when another AR terminal is detected within the AR scene, further sharing the AR scene and interactions together.

Reference to “one embodiment” or “an embodiment” or “one implementation” or “an implementation”, as well as other variations thereof, mean that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, moving the information, copying the information, calculating the information, predicting the information, or estimating the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory or optical media storage). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

1.-24. (canceled)

25. A method comprising,
obtaining data representative of an augmented reality scene comprising at least a map and at least one virtual object and data representative of a capture of a real environment by a first apparatus;
determining a localization and an orientation of the first apparatus; and
displaying a representation of the augmented reality scene comprising the data representative of the capture of the real environment, on which is overlaid a representation of the data representative of the augmented reality scene, on which is overlaid a representation of the map, on which is overlaid a representation of the localization and the orientation of the first apparatus.

26. The method of claim 25, further comprising:
obtaining information representative of a localization and an orientation of a second apparatus displaying the augmented reality scene; and
overlaying a representation of the localization and the orientation of the second apparatus over the other representations.

27. The method of claim 25, wherein the representation of the map is resized responsively to user input.

28. The method of claim 25, wherein the representation of the map is displayed with a level of transparency.

29. A first apparatus comprising a processor configured to:
obtain data representative of an augmented reality scene comprising at least a map and at least one virtual object and data representative of a capture of a real environment by the first apparatus;
determine a localization and an orientation of the first apparatus; and
display a representation of the augmented reality scene comprising the data representative of the capture of the real environment, on which is overlaid a representation of the data representative of the augmented reality scene, on which is overlaid a representation of the map, on which is overlaid a representation of the localization and the orientation of the first apparatus.

30. The first apparatus of claim 29, wherein the processor is further configured to:
obtain information representative of a localization and an orientation of a second apparatus displaying the augmented reality scene; and
overlay a representation of the localization and the orientation of the second apparatus over the other representations.

31. The first apparatus of any of claim 29, wherein the representation of the map is resized responsively to user input.

32. The first apparatus of claim 29, wherein the representation of the map is displayed with a level of transparency.

33. A first apparatus comprising a processor configured to:
obtain data representative of an augmented reality scene comprising at least a map and at least one virtual object and data representative of a capture of the real environment by the first apparatus;
determine a localization and an orientation of the first apparatus; and
preparing for display and providing a representation of the augmented reality scene comprising the data representative of the capture of the real environment, on which is overlaid a representation of the data representative of the augmented reality scene, on which is overlaid a representation of the map, on which is overlaid a representation of the localization and the orientation of the first apparatus.

34. The first apparatus of claim 33, wherein the processor is further configured to:
obtain information representative of a localization and an orientation of a second apparatus displaying the augmented reality scene; and
overlay a representation of the localization and the orientation of the second apparatus over the other representations.

35. The first apparatus of any of claim 33, wherein the representation of the map is resized responsively to user input.

36. The first apparatus of claim 33, wherein the representation of the map is displayed with a level of transparency.

37. An augmented reality system comprising:
data representative of an augmented reality scene;
a plurality of augmented reality terminals configured according to claim 29; and
an augmented reality controller configured to manage the data representative of the augmented reality scene and to manage interactions between the plurality of augmented reality terminals, comprising providing a position and an orientation of one of the augmented reality terminals to the other augmented reality terminals of the plurality.

38. A non-transitory computer readable medium comprising program code instructions for implementing the steps of a method according to claim 25 when executed by a processor.
